(19) United States
(12) Patent Application Publication
(10) Pub. No.: US 2008/0294733 A1
(43) Pub. Date: Nov. 27, 2008

(54) REMOTE SERVICES FOR THIN CLIENT

(75) Inventor: Michael R. Manzano, Seattle, WA (US)

Correspondence Address: BLACK LOWE & GRAHAM, PLLC, 701 FIFTH AVENUE, SUITE 4800, SEATTLE, WA, 98104, US

(73) Assignee: Topia Technology, Tacoma, WA (US)

(21) Appl. No.: 11/954,081

(22) Filed: Dec. 11, 2007

Related U.S. Application Data
(60) Provisional application No. 60/869,451, filed on Dec. 11, 2006.

(51) Int. Cl. G06F 15/16

(52) U.S. Cl. 709/206

(57) ABSTRACT

In an embodiment, instead of a desktop operating system providing basic services, such as file storage and/or identity management, the services may be instead migrated onto a network. Applications running under this new platform use remote servers as a mechanism for providing basic services that were previously provided by the desktop operating system.

### PRIORITY CLAIM

The present application claims priority from U.S. Provisional Application No. 60/869,451 filed Dec. 11, 2006 which is incorporated by reference as if fully set forth herein.

### BACKGROUND OF THE INVENTION

One of the most visible and important movements in the evolution of computing systems is being led by “Web 2.0”, a term coined by Tim O'Reilly during a conference brainstorming session between O'Reilly and MediaLive International. The founding principle of the Web 2.0 initiative is the movement away from a desktop-based platform to a Web-based platform.

User-interface-Current HTML, DOM and/or Javascript-based technologies (a.k.a. AJAX) may be only moderately successful in delivering acceptable usability.

Restrictions in these technologies, specifically the way it prevents access to local computing resources, hamper the development of rich interaction techniques needed to provide a good user experience. Although AJAX may be adequate for the simplest of interface tasks, a new model for creating rich user interfaces that can be deployed from the server may be desirable.

### BRIEF DESCRIPTION OF THE DRAWINGS

Preferred and alternative embodiments of the present invention are described in detail below with reference to the following drawings.

FIG. 1 is a functional block diagram of an exemplary operating environment in which an embodiment of the invention can be implemented;

FIG. 2 is a functional block diagram of an exemplary operating environment in which an embodiment of the invention can be implemented;

FIG. 3 is a functional block diagram of an exemplary operating environment in which an embodiment of the invention can be implemented; and

FIG. 4 is a functional block diagram of an exemplary operating environment in which an embodiment of the invention can be implemented.

### DETAILED DESCRIPTION OF THE PREFERRED EMBODIMENT

In an embodiment, instead of a desktop operating system providing basic services, such as file storage and/or identity management, the services may be instead migrated onto a network. Applications running under this new platform use remote servers as a mechanism for providing basic services that were previously provided by the desktop operating system.

There are many emerging technologies related to the Web 2.0 movement. An embodiment includes a particularly innovative vision to realizing Web 2.0 that involves existing and/or deployed standards-based technologies. Furthermore, this vision has synergy with the open source movement, an optionally advantageous force for motivating innovation.

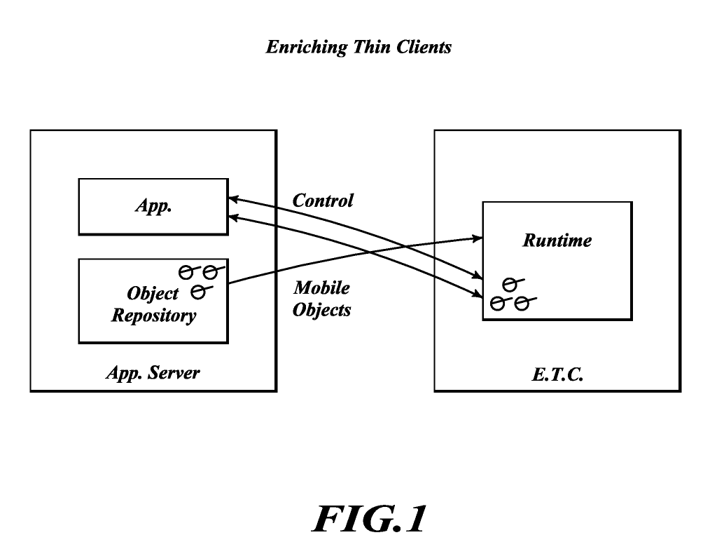

In an embodiment, and as illustrated in FIG. 1, the enrichable thin client (ETC) may be a concept enabled by an infrastructure technology (features of which may be described, for example, in commonly owned U.S. patent application Ser. No. 10/617,604 filed Jul. 11, 2003, U.S. patent application Ser. No. 10/627,203 filed Jul. 25, 2003, U.S. patent application Ser. No. 10/630,637 filed Jul. 29, 2003, U.S. patent application Ser. No. 11/739,083 filed Apr. 23, 2007, U.S. patent application Ser. No. 11/739,084 filed Apr. 23, 2007, U.S. patent application Ser. No. 11/739,085 filed Apr. 23, 2007 and U.S. patent application Ser. No. 11/757,220 filed on Jun. 1, 2007, each of which is hereby incorporated by reference as if fully set forth herein) that deploys server-based applications to end users in a transparent fashion. Although applications in the ETC concept may be server-based, user experience may be aggressively pursued to equal or exceed the user experience of current desktop applications. Further, the ETC concept preserves the advantages of hosting applications on a server. Embodiments of the invention can be implemented using mobile agent objects, the nature and functionality of which are described in one or more of the aforementioned commonly owned patent applications.

A major problem with the AJAX paradigm is that it may be designed in such a way that prevents implementation of innovative document and/or data storage solutions. In this new network-centric platform, data may be stored so that it accessible from anywhere on the Web, but at the same time be available to disconnected users. Furthermore, data modified by the user while disconnected may be transparently synchronized with the network when the computing device is reconnected to the network.

In the Internet age, not only is communication speed increasing, so is the pace of application development. This speed may be a direct result of several trends:

Open source—Adoption of standards, protocols and/or frameworks have accelerated due to the open source movement. Open source, when applied correctly, exposes application design so that it can be better secured, allows modification so that technologies can be easily adapted to a particular use, and/or provides an environment in which innovation may be unhampered by business constraints.

Better development technology—Development tools based on the editcompile-debug cycle can rapidly be replaced by tools focused on prototype-oriented design. In this type of design, an application can be “sketched” with code to provide a rough working version of an application that can then be evaluated by a client. This tight loop of prototype generation and/or validation greatly increases the speed of application development.

Each desktop-based service that may be migrated onto the Web may be a new opportunity to provide valuable services to an end user. To make ETC work, several core services may be created to provide a complete user experience. This section will discuss these services:

Application Search—Because applications served from the Web do not have to be pre-installed on a computing device to be used, the number of applications available increases by orders of magnitude. A system may be found to efficiently connect users with needed applications.

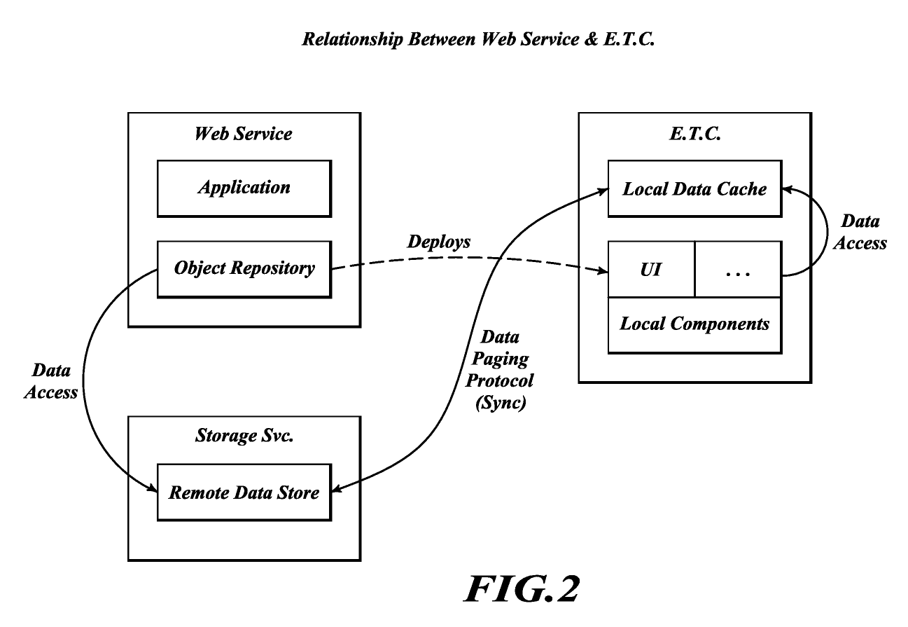

Data Store—As illustrated in FIG. 2, a user's data on a Web-based platform may reside on a system the user trusts. Currently, web applications store user data on servers owned by the providers of that web application. An opportunity exists to provide a trusted third-party data storage service to users that may be fully integrated with ETC-related technologies.
Identity—In contrast to the desktop platform paradigm, where a user's identity may be tied directly to the computing device he is using, the ETC's Web-based computing model may be comprised of a series of interconnected machines run by different vendors. To ensure a unified user experience, a service may be created to track a user's identity across the networks.

This service may employ user authentication technologies. Such a service may also track relationships among users to enable the ability for users to work in groups. ETC devices can also provide a method to exchange identification information between users who may be physically located in the same place to automate identity exchange and/or ad-hoc workgroup formation.

Communication Services

The migration of services that were currently under the purview of the desktop operating system to the Web redefines what it means to communicate. If data may be stored on the network, communication of that data becomes less about its transmission, and more about user authentication and/or permissions-based security.

“Sending” a document becomes a data authorization activity that can be provided as a network-based service. As such, communication mechanisms that existed in the desktop era become value-add services that can be provided in the same way as core services.

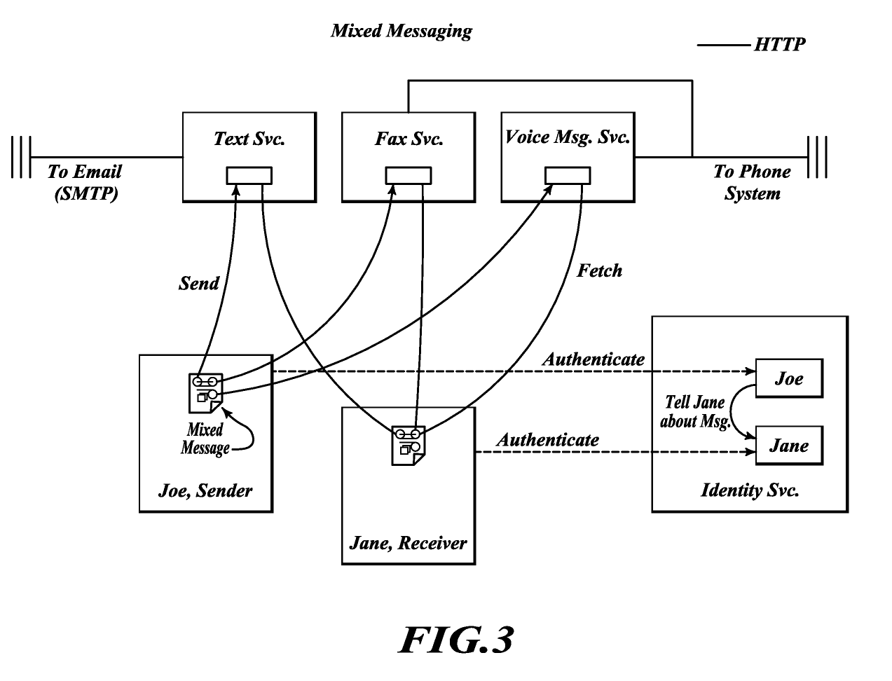

As illustrated in FIG. 3, communication media such as chat, email, voice mail, text messaging and/or others may be redefined as Web services. In this paradigm, all messages can be universally addressed using a universal resource locater (URL) allowing them to be freely mixed and/or matched. This feature, in effect, provides a natural multimedia messaging environment. For example, it becomes possible to mix instant messaging with voice mail to provide instant voice messaging.

ETC for Small Form Factor Devices

In an embodiment, Enriched Thin Client (ETC) is a computing concept that provides ASPs with technologies that accelerate their ability to deliver desktop-quality applications without sacrificing the positive characteristics of hosted applications. ETC is the next logical step in the evolution of technology related to AJAX (asynchronous JavaScript and XML), commonly associated with “Web 2.0”, a term used by the industry to describe the transformation of the web into the next-generation general computing platform.

Because ETC tackles issues related to mobile computing, many of its strategies align well with small form factor devices, such as UMPCs, PDAs and/or smart phones.

Extending Web 2.0 concepts

Contemporary web development technologies may be focused on the creation of hosted applications. This suite of tools includes:

HTML

HTTP

JavaScript

XML

DOM

CSS

Several aspects make these technologies ideal for application development:

Short turn-around time for application development.

Application maintenance (such as installation and/or configuration) may be performed by the application developer so the user doesn't have to.

Because the hardware used to run an application may be fully controlled by the application developer, the developer can completely customize the execution environment to assure optimal efficiency at all times.

However, applications created with these technologies have several usability shortcomings when compared to desktop applications. These shortcomings may be:

Dependence on a network connection to function.

Applications run completely on the server and therefore do not make good use of the client machine's resources.

The user interface may be retrofitted into a framework designed for the presentation of documents, not desktop interfaces.

Data belonging to a user may be stored by the application used to create it; the user has no choice.

ETC tackles these shortcomings by adding components to the aforementioned suite of web technologies.

Further, in an embodiment, ETC provides applications with capabilities beyond those of desktop applications by leveraging its implementation as a network-based technology:

Since the user's data may be primarily stored on the network, the user always has access to his data regardless of location and/or the hardware he's using

As the majority of an ETC-based application runs on a server, applications can run on client hardware with minimal resources without detrimentally affecting the user's experience

Applications, and/or application updates, need not be explicitly installed by the end user. Installation may be automatic.

Because user data may be always available on the network, data sharing becomes less about transmission and more about authenticated access to a user's network data store

ETC may automatically cache code and/or data wherever it may be needed on a network, fetching and/or purging as needed

Especially because of the last point, ETC may be an optimal platform for building and/or deploying communication-related applications for small form-factor devices such as UMPCs, smart phones, and/or cell phones.

Many of the features which make ETC an optimal platform for general computing also make it optimal for applications intended for use on small form factor devices.

Tying user data to identity

The basic building block of any type of communication may be the establishment of user identity. Without an agreed upon method for identifying people, no message can be addressed.

Many messaging services identify the user by an ID whose management may be closed to other application developers. Because of this closed nature, a user using these services may manage many separate identities. Another consequence of inaccessible identity information may be that universally storing, accessing and/or sharing contact and/or point-of-presence information becomes an intractable problem. In an embodiment, ETC overcomes these problems by adopting the concept of identity federation.

Identity federation may be the ability to use a single ID to universally identify a user across many services. There may be already several open solutions that provide this capability, including OpenID, WS-Trust, and/or SAML. Using identity federation as a basis for service-independent identification, ETC ties a user to his data independently of the application that he used to generate it.

ETC defines a hosted service for storing user data separately from hosted applications and/or users' devices. ETC can launch with an implementation of this service, but the protocol used to access it may be open. This allows 3rd party providers the ability to provide similar services.

Auto-Caching Remote Data Storage

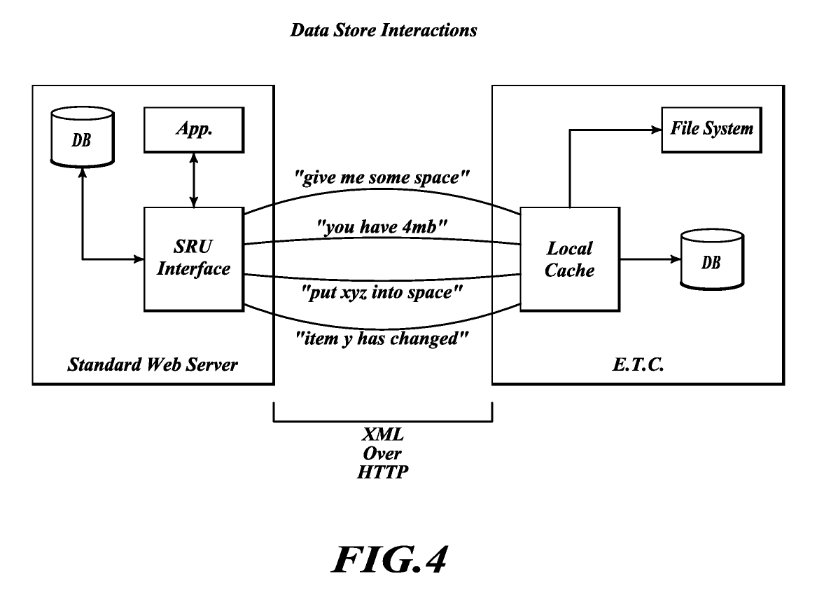

As illustrated in FIG. 4, for example, once data has been associated with identity, and/or a storage service is provisioned, there must be some way for a user and/or his applications to access his data. In an embodiment, ETC provides a mechanism that caches data so that it may be local to both the user's device and/or the application servers. These data caches may be tightly managed by ETC. ETC employs an algorithm that ensures the network may be used as efficiently as possible, respects the resource limitations of the devices, and/or keeps data the user or application may be likely to access local.

Because, in an embodiment, ETC propagates data across the network on an as-needed basis, it may remove the need for the user to manually move data around. This capability may be optionally advantageous to portable devices because it obviates the need for syncing, and/or provides the user a method to use data when offline.

Automatic Application Component Deployment

In an embodiment, ETC fully manages not only data, but also application components. Similar to the auto-caching feature for data, ETC provides a way for application components to migrate capability to both user devices and/or application servers.

ETC may require an initial installation on a user's devices. The software can be pre-bundled with the device. Alternatively, the user can download it from the Internet.

In an embodiment, after the initial installation, all subsequent application installations and/or updates may require no user intervention. This greatly reduces the learning curve for users who wish to enhance their device's capabilities. It also becomes easier for vendors to roll out their applications as they do not need to invent a deployment system.

The ability for ETC to automatically maintain application components on a user's device may be advantageous to users, IT professionals, and/or application vendors in that everyone may be always using the latest and/or same version of the application.

In an embodiment, beyond application installation and/or update, ETC fully manages the application's components in a fashion similar to how it manages user data. ETC not only transfers the components around, but also their running state. This capability may be employed by ETC to ensure a consistent application state even if users switch devices in the middle of an operation.

An optionally advantageous side effect of this state preserving process may be that if the user wishes to go offline, or if a user may be in a context with no network access, everything they need to continue working (their data, application components and/or operational state) may be already on their device.

Messaging by Document Sharing

With the wide adoption of TCP/IP, communication of messages has been primarily about the transmission of a special data type designated to be a message. With the advent of multimedia-enabled computers, a need arose to transmit data types that were media-rich. Such transmissions, especially in the form of email attachments, may be cumbersome to manage.

In an embodiment, ETC takes advantage of the fact that it stores user data on the network to simplify messaging. Although transmission still occurs, it happens transparently during document editing within the ETC-defined auto-caching mechanism. When messaging needs to occur, the “recipient” may be simply given permission to access a document (on a particular storage server) by the “sender”. The data related to the message may be transferred to the recipient's machine by the auto-caching mechanism on an as-needed basis without requiring user intervention.

In an embodiment, ETC allows users to control access to their documents at granularities smaller than the document itself. This allows for the messaging of portions of the document. For example, a user could share just the email address part of the document that contains his identity information.

In an embodiment, and as illustrated in FIG. 3, ETC augments store-and/or-forward style messaging, which includes email and/or voice mail, as messaging data may be naturally transferred to the server during its creation by the auto-caching system. The data that composes the document to be sent may be naturally migrated to the server—in this case; the server may be the “store” part of “store-and-forward”—and from there access permissions may be given to the recipients.

In an embodiment, because the message store coincides with ETC's natural data storage mechanism, ETC removes the messaging step normally required to move a message from data storage to message storage.

For example, in email this step occurs when a file attachment on a disk drive (the data storage) may be transferred via SMTP to an email server (the message store). Upon delivery, the attachment may be deleted from the SMTP server. If that document were to be subsequently attached to a message for a different recipient, the document may again have to be transmitted in it's entirely to the SMTP server. In ETC, because the data store coincides with the message store, this transmission does not need to happen again.

Integration with Local Resources

Contemporary PDAs and/or smart phones are increasingly including specialized hardware relevant to mobile users, such as cameras and/or voice recorders. Currently, server-based applications can't access data generated by this hardware without a lot of development effort, and/or much user intervention.

In an embodiment, ETC provides an interface to this hardware that may be accessible from web-based languages, such as JavaScript. This accessibility exposes specialized device-generated data to ETC's auto-caching mechanism, and therefore exposes this data to hosted applications.

First Class User Interface

A problem with contemporary server-side applications is that they may be generally limited to the capabilities of HTML and/or CSS to present a user interface. This set of technologies was designed to present documents, not the control interfaces that are more common in desktop applications. Because both types of interfaces may be optionally advantageous, ETC's strategy may be to augment AJAX with an interface tool kit to make control interfaces easy to build using high-level languages such as XML.

Some of the challenges related to current web technologies' ability to present on small form factor devices include:

Difficult to implement control-style interfaces

Difficult to integrate specialized hardware UIs into a single unified presentation

Limited processing and/or memory resources available to generate advanced data visualization

ETC may be also concerned with challenges related to devices other than ones with a small form factor. As users of small form factor devices typically also use devices with alternate form factors, these issues are optionally advantageous to tackle:

Seamless workflow between multiple devices with different form factors

Ensure application state may be current when switching between devices

A solution to these issues may allow a user to move from one device to another seamlessly and continue working.

In an embodiment, ETC addresses these issues by augmenting the presentation capabilities of AJAX. It defines an open system for describing control interfaces in a way that allows them to be transmitted to a client for execution.

Once active, the interface may convert interface events into action. In AJAX applications, action may be supplied by JavaScript embedded in the HTML document. In an embodiment, ETC provides its own mechanism to allow control interfaces to decide what execution environment (which includes the Java Script environment) to use to perform the required actions.

In an embodiment, along with transferring the user interface description, ETC also ensures that the logic for the action, as well as its execution environment, may be available. Because of this ability to transfer logic, configuration, and/or state at will, ETC may be not limited to user interfaces and/or behavior that have been preinstalled on a device. As far as the user is concerned, an appropriate user interface may be always presented for the application he's using.

ETC: A Platform for Unified Mobile Communication

In an embodiment, ETC provides application developers with a suite of tools built on open standards for developing world-class applications. As with any other application, communications services such as email, instant messaging, and/or voice messaging may be immediately augmented by virtue of being based on a naturally distributed, network-born platform.

Further, as application functionality in ETC may be naturally accessible on the network, it becomes an almost trivial job to create unified mailbox services: user interfaces from disparate communication applications can be freely intermixed, obviating the need for complex message translations. If a translation may be needed, translation services can be daisy chained effectively due to the decoupling of user data from application.

As users become more mobile, new solutions may be needed to support seamless computing across multiple locations and/or devices. ETC may be a platform that is uniquely positioned to enable this transformation.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising the steps of:
receiving over a network from a sending party a voice message intended for a receiving party;
receiving over the network from the sending party a text message intended for the receiving party;
receiving over the network from the receiving party an identifier of the receiving party;
receiving over the network from a remote device data authenticating the identifier; and
in response to receiving the data, providing over the network the voice message and text message to the receiving party.
